(19) United States
(12) Patent Application Publication
(10) Pub. No.: US 2012/0218630 A1
(43) Pub. Date: Aug. 30, 2012

(54) Wide Angle Telescope with Five Mirrors

(75) Inventor: Philippe MARTIN, Mougins (FR)

(73) Assignee: THALES, Neuilly-sur-Seine (FR)

(21) Appl. No.: 13/398,637

(22) Filed: Feb. 16, 2012

(30) Foreign Application Priority Data
Feb. 24, 2011 (FR) 11 00550

(51) Int. Cl. G02B 23/02

(52) U.S. Cl. 359/366; 359/364; 359/365

(57) ABSTRACT

A wide angle catoptric telescope comprises five successive off-axis mirrors. The first mirror or entrance mirror of the five mirrors is concave. The entrance pupil of the telescope is real and situated in front of this said first mirror. The second and the fourth mirror are convex. The third and the fifth mirror are concave. The optical combination is telecentric, and the image field is plane.

### CROSS-REFERENCE TO RELATED APPLICATION

This application claims priority to foreign French patent application No. FR 1100550, filed on Feb. 24, 2011, the disclosure of which is incorporated by reference in its entirety.

### FIELD OF THE INVENTION

The domain of the invention is that of telescopes and more particularly observation telescopes aboard satellites. More precisely, the domain of the invention relates to wide angle catoptric systems, allowing terrestrial or space observation in a broad spectral band.

### BACKGROUND

Generally, these telescopes have a large angular field in a first direction and an angular field of lesser magnitude in the perpendicular direction. This arrangement makes it possible to produce optical architectures comprising solely off-axis mirrors without central occlusion. This type of architecture makes it possible to produce compact telescopes, having very good transmission and free of chromatic aberrations. However, these optical architectures are often complex in so far as the image quality must be excellent in a large field.

Currently, a first type of optical architecture of anastigmatic telescopes comprises three mirrors. These telescopes are also called “TMA telescopes” according to the terminology signifying “Three Mirrors Anastigmat”. TMA telescopes offer angular fields of generally between 25° and 30° while correcting the so-called third-order geometric aberrations. But beyond this field, the degradations of the image become significant. Thus, U.S. Pat. No. 5,379,157 from the Hugues Aircraft company describes a combination of this type. This field limitation is not suited to the trends in earth observation missions which require, ever more, wide linear fields so as to increase the instantaneous field covered by the instrument during rotation about the earth. The importance of these missions is to photograph a wide field at regular intervals. In this context, the telescopes of TMA type are no longer sufficient to cope with the missions requiring the photographing of large fields.

A solution making it possible to increase the field is the use of a second type of architecture of anastigmatic telescopes comprising four mirrors, also called in the technical terminology “FMA” for “Four Mirrors Anastigmat”. Application EP 0 601 871 from the Hugues Aircraft company describes such a combination. Patent FR 2 764 081 from the Sagem company details a telescope comprising four mirrors whose field possesses a maximum angular width of 70°. Finally, application EP 2 073 049 from the Thales company and from the same inventor also describes an optical architecture with four mirrors where the large field is raised to 85°.

However, conventional “TMA” or “FMA” telescopes have a convex primary mirror and a virtual entrance pupil. This absence of real pupil presents several drawbacks. In the absence of a real entrance pupil, it is impossible or very difficult to accommodate a diffuser, a depolarizing window or a removable cowl at the instrument input and thus to calibrate it or to protect it very effectively. A real entrance pupil facilitates the interface between the telescope and other instruments.

### SUMMARY OF THE INVENTION

Hence, one of the aims of the invention is to remedy these drawbacks by producing an optical architecture with real entrance pupil. This new type of architecture presents, moreover, the advantage of exceeding the current field width limitations for observation telescopes.

More precisely, the subject of the invention is a wide angle catoptric telescope, characterized in that:
the telescope comprises five successive off-axis mirrors denoted respectively and in the order of succession first, second, third, fourth and fifth mirror;
the first mirror or entrance mirror of the said five mirrors is concave;
the entrance pupil of the telescope is real and situated in front of this said first mirror.

Advantageously, the first mirror is spherical.

Advantageously, the exit pupil, that is to say the image of the entrance pupil through the five mirrors, is at infinity, the telescope thus being telecentric.

Advantageously, the second mirror is convex and aspherical.

Advantageously, the third mirror is concave, the fourth mirror is convex and the fifth mirror is concave.

Advantageously, at least the third or the fourth or the fifth mirror is conical.

Advantageously, if R1 is the radius of curvature at the vertex of the first mirror, the radius of curvature at the vertex of the second mirror R2 equals substantially 0.5.R1, the radius of curvature at the vertex of the third mirror R3 equals substantially 1.2.R1, the radius of curvature at the vertex of the fourth mirror R4 equals substantially 0.8.R1, the radius of curvature at the vertex of the fifth mirror R5 equals substantially 0.9.R1, the focal length of the telescope being equal to 0.25.R1.

Advantageously, the object field of the telescope is substantially rectangular, the width of the rectangle being at least 1 degree and its length at least 100 degrees.

Finally, the image field is substantially plane.

### BRIEF DESCRIPTION OF THE DRAWINGS

The invention will be better understood and other advantages will become apparent on reading the nonlimiting description which follows and by virtue of the appended figures among which:

FIG. 1 represents an exemplary optical architecture of a telescope according to the invention in the symmetry plane of the telescope;

FIG. 2 represents the optical architecture of FIG. 1 in a plane perpendicular to the symmetry plane, three light rays of the central field being represented;

FIG. 3 represents the optical architecture of FIG. 1 in a plane perpendicular to the symmetry plane, three light rays of the extreme field being represented;

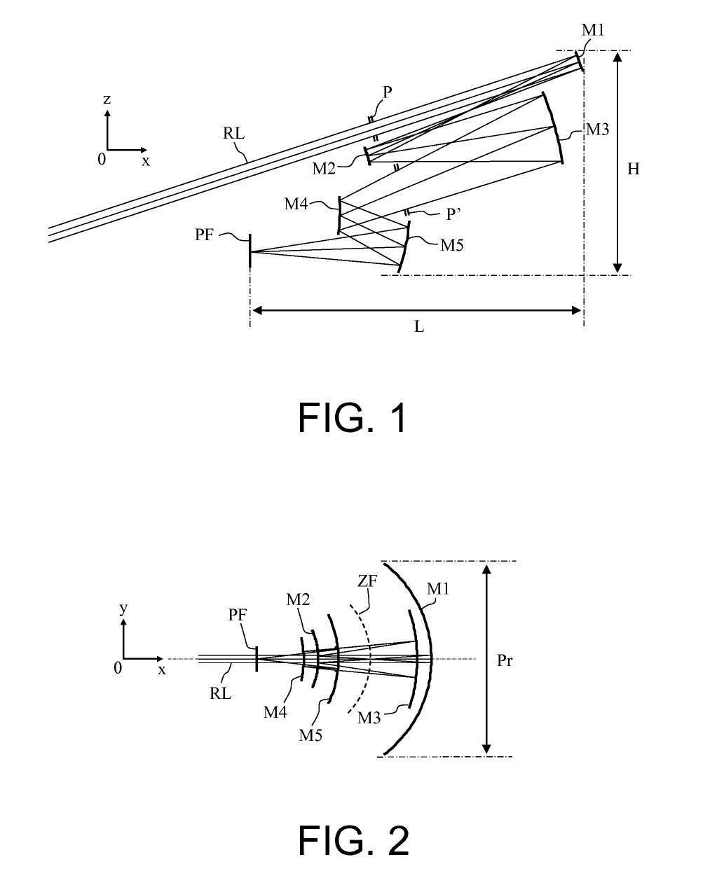

Finally, FIG. 4 represents the optical architecture of FIG. 1 in a plane perpendicular to the symmetry plane, two symmetric light rays of the extreme fields being represented.

### DETAILED DESCRIPTION

The particular feature of the telescopes according to the invention is to work with object fields that are very significant in one direction and small in the perpendicular direction. This particular arrangement makes it possible to construct optical architectures comprising only mirrors without central occlusions, the mirrors being sufficiently off-axis to reflect the light rays of one mirror towards the next mirror without occluding same.

Whereas the optical architectures of the prior art possess three or four mirrors, the telescope according to the invention is a combination with five mirrors, the first mirror being concave. The addition of this fifth mirror presents numerous advantages over the previous solutions. This arrangement makes it possible to obtain:
a very large field, of the order of 100 degrees;
very good image quality, limited by diffraction over the whole of the field;
low distortion along the field, not exceeding +/−1.25 degrees, whereas the best solutions of “TMA” and “FMA” type have twice as much distortion;
a real entrance pupil;
an architecture of telecentric type at output, ideal for accommodating an entrance slit of a spectrometer;
a plane image field.

By way of example, FIGS. 1 to 4 represent a telescope optical architecture according to the invention in two different sectional planes, the first (O, x, z) is situated in the symmetry plane of the telescope, the second (O, x, y) is situated in a perpendicular plane. The optical architecture comprises five mirrors denoted M1, M2, M3, M4 and M5. In these various figures, the mirrors are represented by thick lines. The focal plane PF is also represented by thick lines. The light rays RL are represented by thin lines, the pupils P and P′ by double lines and the intermediate focusing zone ZF by dashed lines.

The first mirror M1 is a spherical concave mirror. The entrance pupil P of the telescope is situated in the vicinity of the centre of curvature of this first mirror M1. This mirror gives from the object field at infinity a curved intermediate real image situated in the intermediate focusing zone ZF situated between the first mirror M1 and the second mirror M2.

The set of four mirrors M2, M3, M4 and M5 gives from this intermediate real image a real image devoid of geometric aberrations in the focal plane PF.

The mirrors M2 and M3 form, from the image of the pupil P, an intermediate image P′ situated between the mirror M2 and the mirror M3. The image of this pupil P′ is collimated at infinity by the mirrors M4 and M5. Thus, the optical combination is telecentric, signifying that, whatever the object field, the light rays passing through the centre of the entrance pupil are all parallel to one another in the vicinity of the focusing plane. This arrangement greatly facilitates the adaptation of measurement instruments such as spectroscopes arranged in the focal plane PF. Moreover, the image field is plane, thereby further facilitating the placement of the photosensitive surface of a detector or the entrance slit of a spectrometer.

In FIGS. 1 and 2, three rays RL represent the path of the light rays arising from the central field through the telescope, the central ray passes through the centre of the pupil P, the other two rays pass through the edges of the pupil.

In front of the telescope, these three rays are mutually parallel. They are focused a first time at the level of the intermediate focusing zone ZF and then a second time at the level of the focal plane PF. The off-axis offset of the mirrors is calculated so as not to cause vignetting of these rays.

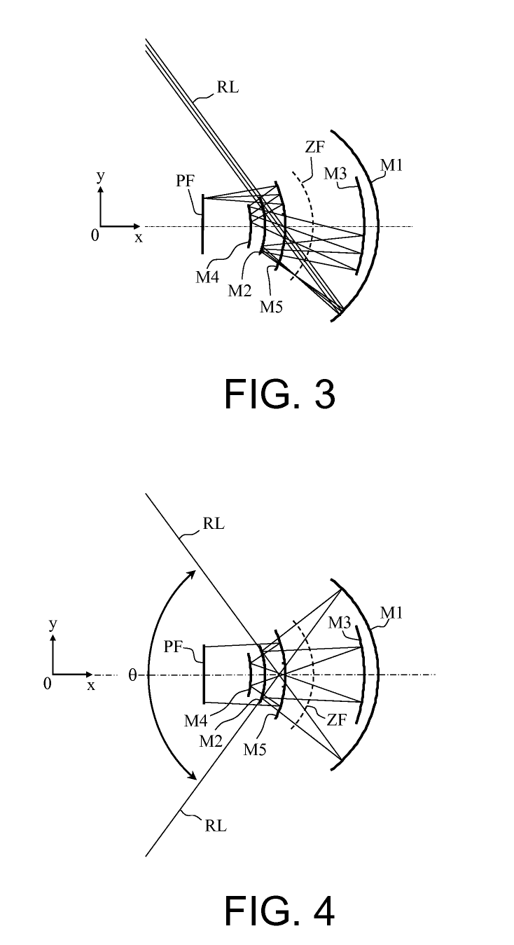

In FIG. 3, three rays RL represent the path of the light rays arising from an extreme field through the telescope, the central ray passes through the centre of the pupil P, the other two rays pass through the edges of the pupil.

In front of the telescope, these three rays are mutually parallel. They are focused a first time at the level of the intermediate focusing zone ZF and then a second time at the level of the focal plane PF. The central ray is perpendicular to the focusing plane.

FIG. 4 represents the two rays arising from the two ends of the field.

The mirrors M2 and M4 are convex and the mirrors M3 and M5 are concave. The four mirrors M2, M3, M4 and M5 are aspherical or conical. More precisely, the profile Z of the representative surface of these mirrors as a function of the distance h from the vertex to a point P of the surface satisfies:

$$Z = \frac{\frac{{h}^{2}}{R}}{1 + \sqrt{1 - ( 1 + k ) \cdot \frac{{h}^{2}}{{R}^{2}}}} + {Ah}^{4} + {Bh}^{6} + {Ch}^{8} + {Dh}^{10}$$

with:

R: radius of curvature at the vertex of the surface;

k: conicity constant of the surface;

A: profile constant of order 4;

B: profile constant of order 6;

C: profile constant of order 8;

D: profile constant of order 10.

More precisely, the mirror M2 is convex aspherical of order 6, the mirror M3 is concave conical, the mirror M4 is convex conical and the mirror M5 is concave conical.

The tables hereinbelow give the main geometric characteristics of an optical architecture according to the invention. Table I gives the geometric parameters of the mirrors and table II the main distances separating these mirrors.

TABLE I

| | | Radius of | | | |
|---|---|---|---|---|---|
| | | curvature | | A | B |
| | Shape | mm | k | mm⁻³ | mm⁻⁵ |
| M1 | Concave Spherical | 26.2 | — | — | — |
| M2 | Convex aspherical | 15.5 | 0.85 | 0 | −0.18 × 10⁻⁷ |
| M3 | concave conical | 32.16 | 0.08 | — | — |
| M4 | convex conical | 21.8 | 2.09 | — | — |
| M5 | concave conical | 23.8 | 0.51 | — | — |

TABLE II

| Distance | mm |
|---|---|
| M1-M2 | 24.5 |
| M2-M3 | 20.1 |
| M3-M4 | 24.7 |
| M4-M5 | 7.7 |
| M5-Focal plane | 18.2 |

Under these conditions, the entrance pupil is situated 21 mm in front of the mirror M1, the exit pupil is at infinity, the resulting focal length of the telescope equals 6.8 mm. The object field θ in the plane (O, x, y) is of the order of 100 degrees and in the plane (O, x, z) of the order of a degree.

The overall proportions of this optical combination are as follows:

Length L: 67 mm

Height H: 25 mm

Depth Pr: 44 mm

The quality of the image throughout the fields is limited by diffraction.

1. A wide angle catoptric telescope, an angular object field of the telescope being rectangular, a width of the rectangle being of an order of 1 degree and its length at least 100 degrees, comprising:
five successive off-axis mirrors denoted respectively and in order of succession as a first mirror, a second mirror, a third mirror, a fourth mirror, and a fifth mirror;
wherein the first mirror, being an entrance mirror, of said five mirrors is concave; and
wherein an entrance pupil of the telescope is real and situated in front of said first mirror.

2. The catoptric telescope according to claim 1, wherein the first mirror is spherical.

3. The catoptric telescope according to claim 1, wherein an exit pupil, or image of the entrance pupil through the five mirrors, is at infinity, the telescope being telecentric.

4. The catoptric telescope according to claim 1, wherein the second mirror is convex.

5. The catoptric telescope according to claim 4, wherein the second mirror is aspherical.

6. The catoptric telescope according to claim 1, wherein the third mirror is concave.

7. The catoptric telescope according to claim 1, wherein the fourth mirror is convex.

8. The catoptric telescope according to claim 1, wherein the fifth mirror is concave.

9. The catoptric telescope according to claim 6, wherein at least the third or the fourth or the fifth mirror is conical.

10. The catoptric telescope according to claim 1, wherein, if R1 is the radius of curvature at the vertex of the first mirror, the radius of curvature R2 at the vertex of the second mirror equals substantially 0.5 times R1, the radius of curvature at the vertex of the third mirror equals substantially 1.2 times R1, the radius of curvature R4 at the vertex of the fourth mirror equals substantially 0.8 times R1, the radius of curvature R5 at the vertex of the fifth mirror equals substantially 0.9 times R1, the focal length of the telescope being equal to 0.25 times R1.

11. The catoptric telescope according to claim 1, wherein the image field is substantially plane.

12. The catoptric telescope according to claim 7, wherein at least the third or the fourth or the fifth mirror is conical.

13. The catoptric telescope according to claim 8, wherein at least the third or the fourth or the fifth mirror is conical.
